(19) United States
(12) Patent Application Publication
(10) Pub. No.: US 2019/0273573 A1
(43) Pub. Date: Sep. 5, 2019

(54) HIGH-RATE TRELLIS CODED MODULATIONS

(71) Applicant: QUALCOMM Incorporated, San Diego, CA (US)

(72) Inventors: Seyed Mohammad Ehsan Hosseini, San Diego, CA (US); Koorosh Akhavan, San Diego, CA (US)

(21) Appl. No.: 16/271,316

(22) Filed: Feb. 8, 2019

Related U.S. Application Data
(60) Provisional application No. 62/638,896, filed on Mar. 5, 2018.

(51) Int. Cl. H04L 1/00

(52) U.S. Cl. CPC H04L 1/006; H04L 1/0068; H04L 1/0041

(57) ABSTRACT

A device (e.g., a wireless device) may obtain a set of encoded bits, and select a set of symbol locations for puncturing. The device may then obtain and transmit modulated symbols based on the puncturing. For example, the device may encode information bits according to a convolutional code rate. In some cases, the encoded bits may be punctured (e.g., via a puncturing matrix with each column including either all 1's or all 0's) and the set of punctured bits may be mapped to symbols. In other cases, the encoded bits may be mapped to symbols, and the symbols may be punctured (e.g., via a puncturing matrix). The puncturing matrix may be identified based on a desired punctured code rate, the convolutional code rate used to encode the information bits, and whether or not the puncturing is to be applied before or after symbol mapping.

### CROSS REFERENCE

The present Application for Patent claims the benefit of U.S. Provisional Patent Application No. 62/638,896 by HOSSEINI, et al., entitled “High-Rate Trellis Coded Modulations,” filed Mar. 5, 2018, assigned to the assignee hereof, and expressly incorporated herein by reference in its entirety.

### BACKGROUND

The following relates generally to wired (e.g., digital subscriber line (DSL)) and wireless communications, and more specifically to high-rate trellis coded modulations (TCMs).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless local area network (WLAN), e.g., a wireless network supporting communications using air interfaces associated with a different radio access technologies (RATs), such as a Bluetooth (BT) RAT, a Zigbee RAT, a Wi-Fi (i.e., Institute of Electrical and Electronics Engineers (IEEE) 802.11) RAT, etc., may include an access point (AP) that may communicate with one or more stations (STAs) or mobile devices. The AP may be in communication with an external network, such as the Internet, and may enable a STA to communicate with the external network or another STA via the AP. A STA may communicate with an associated AP via downlink and uplink. The downlink (or forward link) may refer to the communication link from the AP to the STA, and the uplink (or reverse link) may refer to the communication link from the STA to the AP.

Communications systems (e.g., wireless communications systems, DSL systems, etc.) often involve devices sending and receiving data over a noisy communication channel. To combat noise, a transmitter may encode data in the form of code blocks using error correcting codes to introduce redundancy in the code block so that transmission errors may be detected and/or corrected. Some examples of encoding algorithms with error correcting codes include convolutional codes, low-density parity-check (LDPC) codes, polar codes, etc. In some cases, such encoding may result in low code rates (e.g., decreased data rates) due to the introduction of redundancy. Higher code rates may be achievable via puncturing of encoded bits. However, in some cases (e.g., such as high-rate TCMs), punctured code may be associated with increased decoding complexity at a receiving wireless device, as the puncturing may alter the decoding trellis of the encoded bits. Increased decoding complexity may result in latency due to decoding operations, and may degrade system performance. Improved techniques for high-rate coded modulations may thus be desired.

### SUMMARY

The described techniques relate to improved methods, systems, devices, or apparatuses that support high-rate trellis coded modulations (TCMs). Generally, the described techniques provide for high-rate TCMs via symbol puncturing schemes that may be associated with reduced decoding complexity. A device (e.g., a wireless device) may obtain a set of encoded bits, and may select a set of symbol locations for puncturing. The device may then obtain and transmit modulated symbols based on the puncturing. For example, the device may encode information bits according to a convolutional code rate. In some cases, the encoded bits may be punctured (e.g., via a puncturing matrix with each column including either all 13 s or all 0's) and the set of punctured bits may be mapped to symbols. In other cases, the encoded bits may be mapped to symbols, and the symbols may be punctured (e.g., via a puncturing matrix). The puncturing matrix may be identified based on a desired punctured code rate, the convolutional code rate used to encode the information bits, and whether or not the puncturing is to be applied before or after symbol mapping (e.g., before or after the mapping of bits to signal constellation points).

A method of communication is described. The method may include obtaining a set of encoded bits by encoding a set of input bits according to a convolutional code, selecting a set of symbol locations based at least in part on a puncturing matrix, where each symbol location of the selected set of symbol locations corresponds to a plurality of encoded bits of the set of encoded bits, obtaining a set of modulated symbols by mapping, for each symbol location of the selected set of symbol locations, the plurality of encoded bits corresponding to that symbol location to a signal constellation point, and transmitting the set of modulated symbols over a communications channel.

An apparatus for communication is described. The apparatus may include a processor, memory in electronic communication with the processor, and instructions stored in the memory. The instructions may be executable by the processor to cause the apparatus to obtain a set of encoded bits by encoding a set of input bits according to a convolutional code, select a set of symbol locations based at least in part on a puncturing matrix, where each symbol location of the selected set of symbol locations corresponds to a plurality of encoded bits of the set of encoded bits, obtain a set of modulated symbols by mapping, for each symbol location of the selected set of symbol locations, the plurality of encoded bits corresponding to that symbol location to a signal constellation point, and transmit the set of modulated symbols over a communications channel.

Another apparatus for communication is described. The apparatus may include means for obtaining a set of encoded bits by encoding a set of input bits according to a convolutional code, means for selecting a set of symbol locations based at least in part on a puncturing matrix, where each symbol location of the selected set of symbol locations corresponds to a plurality of encoded bits of the set of encoded bits, means for obtaining a set of modulated symbols by mapping, for each symbol location of the selected set of symbol locations, the plurality of encoded bits corresponding to that symbol location to a signal constellation point, and means for transmitting the set of modulated symbols over a communications channel.

A non-transitory computer-readable medium storing code for communication is described. The code may include instructions executable by a processor to obtain a set of encoded bits by encoding a set of input bits according to a convolutional code, select a set of symbol locations based at least in part on a puncturing matrix, where each symbol location of the selected set of symbol locations corresponds to a plurality of encoded bits of the set of encoded bits, obtain a set of modulated symbols by mapping, for each symbol location of the selected set of symbol locations, the plurality of encoded bits corresponding to that symbol location to a signal constellation point, and transmit the set of modulated symbols over a communications channel.

In some examples of the method, apparatuses, and non-transitory computer-readable medium described herein, obtaining the set of encoded bits may further include selecting a convolutional code rate, where the convolutional code rate may include a ratio of a number of the set of input bits and a number of the set of encoded bits. Some examples of the method, apparatuses, and non-transitory computer-readable medium described herein may further include operations, features, means, or instructions for encoding the set of input bits to obtain the set of encoded bits based at least in part on the selected convolutional code rate.

In some examples of the method, apparatuses, and non-transitory computer-readable medium described herein, obtaining the set of modulated symbols may further include selecting a punctured code rate. Some examples of the method, apparatuses, and non-transitory computer-readable medium described herein may further include operations, features, means, or instructions for identifying the puncturing matrix based at least in part on the selected punctured code rate and the convolutional code rate.

In some examples of the method, apparatuses, and non-transitory computer-readable medium described herein, the puncturing matrix may be identified based at least in part on the convolutional code rate and a symbol puncturing periodicity. In some examples of the method, apparatuses, and non-transitory computer-readable medium described herein, the identified puncturing matrix may include a plurality of columns including a first column and a second column, where each value of the first column may include a first same value and each value of the second column may include a second same value. In some examples of the method, apparatuses, and non-transitory computer-readable medium described herein, a number of the plurality of columns may be based at least in part on a puncturing period.

In some examples of the method, apparatuses, and non-transitory computer-readable medium described herein, the first same value may be a one and the second same value may be a zero, and where the set of modulated symbols includes at least the first column based at least in part on the first same value and a set of punctured symbol locations includes at least the second column based at least in part on the second same value.

In some examples of the method, apparatuses, and non-transitory computer-readable medium described herein, the plurality of columns includes the first column, the second column, and a third column, where each value of the first column and the second column may be a one and each value of the third column may be a zero. In some examples of the method, apparatuses, and non-transitory computer readable medium described herein, the plurality of columns includes the first column, the second column, and a third column, where each value of the second column and the third column may be a one and each value of the first column may be a zero. In some examples of the method, apparatuses, and non-transitory computer readable medium described herein, the plurality of columns may include the first column, the second column, and a third column, where each value of the first column and the third column may be a one and each value of the second column may be a zero.

In some examples of the method, apparatuses, and non-transitory computer-readable medium described herein, the selected punctured code rate may be 3/4 and the convolutional code rate may be 1/2, and where the plurality of columns includes the first column, the second column, and a third column, where each value of the first column and the third column may include a first same value and each value of the second column may include a second same value.

In some examples of the method, apparatuses, and non-transitory computer-readable medium described herein, the first same value may be a one and the second same value may be a zero, and where the set of modulated symbols includes at least the first column and the third column based at least in part on the first same value and a set of punctured symbol locations includes the second column based at least in part on the second same value.

In some examples of the method, apparatuses, and non-transitory computer-readable medium described herein, the selected punctured code rate may be 5/6 and the convolutional code rate may be 1/3, and where the plurality of columns includes the first column, the second column, a third column, a fourth column, and a fifth column, where each value of the first column and the third column may include a first same value and each value of the second column, the fourth column, and the fifth column may include a second same value.

In some examples of the method, apparatuses, and non-transitory computer-readable medium described herein, the first same value may be a one and the second same value may be a zero, and where the set of modulated symbols includes at least the first column and the third column based at least in part on the first same value and a set of punctured symbol locations includes the second column, the fourth column, and the fifth column based at least in part on the second same value.

Some examples of the method, apparatuses, and non-transitory computer-readable medium described herein may further include operations, features, means, or instructions for puncturing the set of encoded bits based at least in part on the identified puncturing matrix, where the mapping of the set of modulated symbols may be based at least in part on the punctured set of encoded bits.

In some examples of the method, apparatuses, and non-transitory computer-readable medium described herein, selecting the set of symbol locations based at least in part on the puncturing matrix, may further include mapping the set of encoded bits to a plurality of symbols. Some examples of the method, apparatuses, and non-transitory computer-readable medium described herein may further include operations, features, means, or instructions for puncturing the plurality of symbols based at least in part on the puncturing matrix, where the set of symbol locations may be selected based at least in part on the puncturing.

### BRIEF DESCRIPTION OF THE DRAWINGS

FIG. 1 illustrates an example of a wireless communications system that supports high-rate trellis coded modulations in accordance with aspects of the present disclosure.

FIG. 2 illustrates an example of a wireless local area network (WLAN) that supports high-rate trellis coded modulations in accordance with aspects of the present disclosure.

FIGS. 3A and 3B illustrate examples of symbol puncturing implementations that supports high-rate trellis coded modulations in accordance with aspects of the present disclosure.

FIGS. 4A and 4B illustrate examples of rate-3/4 coded quadrature phase shift keying (QPSK) symbol puncturing implementations that supports high-rate trellis coded modulations in accordance with aspects of the present disclosure.

FIG. 5A and 5B illustrate examples of rate-5/6 coded 8PSK symbol puncturing implementations that supports high-rate trellis coded modulations in accordance with aspects of the present disclosure.

FIG. 6 illustrates an example of a process flow that supports high-rate trellis coded modulations in accordance with aspects of the present disclosure.

FIGS. 7 and 8 show block diagrams of devices that support high-rate trellis coded modulations in accordance with aspects of the present disclosure.

FIG. 9 shows a block diagram of a device that supports high-rate trellis coded modulations in accordance with aspects of the present disclosure.

FIG. 10 shows a diagram of a system including a device that supports high-rate trellis coded modulations in accordance with aspects of the present disclosure.

FIGS. 11 through 13 show flowcharts illustrating methods that support high-rate trellis coded modulations in accordance with aspects of the present disclosure.

### DETAILED DESCRIPTION

Both wired and wireless communications may involve sending data over a noisy communication channel. To combat noise, a transmitter (e.g., a transmitting wireless device) may encode data in the form of code blocks using error correcting codes to introduce redundancy in the code block so that transmission errors may be detected and/or corrected at a receiving wireless device. For example, convolutional codes may be used in communications systems to correct for errors in received signals. The Viterbi algorithm, which finds the most likely code word (path), may be used for decoding code words encoded with a convolutional code. The list Viterbi algorithm further reduces the code word error rate by generating a list of the most likely paths, which are then tested in sequence against an error checking function to select the most likely candidate satisfying the error checking function. In decoding algorithms there may be a relationship between list size, packet error rate, and computational complexity.

Convolutional encoders may reduce code rates (e.g., due to introduction of redundancy), although higher transmission rates may be achievable by puncturing encoded bits. However, conventional puncturing of convolutional codes for TCM signals may complicate the receiver design (e.g., conventional puncturing of convolutional codes for TCM may result in increased decoding complexity), and in some cases may reduce system performance. TCM may include convolutional encoding where output bits (e.g., convolutionally encoded bits) are mapped to signal constellation points. A convolutional encoder may be represented on a trellis in which k information bits result in n coded bits at a trellis step. The k/n ratio is referred to as the coding rate (e.g., the convolutional code rate). Higher rate codes may be attainable by puncturing the encoded bits using a puncturing matrix P. The puncturing matrix may have n rows and p columns, where p is the puncturing period. For example, a rate-1/2 convolutional encoder may output two encoded bits for every input (e.g., information) bit. Assuming a puncturing period of p=5, a rate 5/6 code may be achieved using a puncturing matrix

$$P = [ \begin{matrix}1 & 0 & 0 & 1 & 0 \\ 0 & 1 & 1 & 1 & 1\end{matrix} ] \qquad ( 1 )$$

where values of 0 show where puncturing occurs. That is, the rate 5/6 code (using a rate-1/2 convolutional encoder) may be achieved by applying (e.g., multiplying) the puncturing matrix of Equation (1) to the encoded bits. The set of punctured bits may then be mapped to signal constellation points (e.g., symbols) via a modulator (e.g., a mapper). For example, every two bits of the set of punctured bits may be paired for quadrature phase shift keying (QPSK) modulation, every three bits of the set of punctured bits may be paired for 8 phase shift keying (8PSK), etc.

Such puncturing schemes may increase the complexity of the convolutional code's trellis (e.g., which may increase decoding complexity at a receiver). One approach for decoding punctured TCM may include applying the Viterbi algorithm on the punctured (e.g., altered) trellis, and performing a joint demodulation and detection. For example, applying the puncturing matrix of Equation (1) in the example above may result in a trellis with k′=5 input bits and n′=6 output bits (e.g., 3 QPSK symbols) for each branch. In general, the decoding complexity may grow (e.g., exponentially) with k. Therefore, the punctured code may be associated with increased decoding complexity compared to the original code. In variable rate systems, implementation of two decoding structures (e.g., one for the original rate and one for the punctured rate) may be computationally expensive. A second approach for decoding punctured TCM may include separation of demodulation and decoding operations (e.g., as each modulated symbol may correspond to multiple steps on the original trellis). For example, the first QPSK symbol may be constructed from two steps on the trellis in the case where encoded bits are punctured using the puncturing matrix of Equation (1) in the example above. The optimal performance may be achieved if the demodulator provides reliability information (e.g., log-likelihood ratios) for each individual encoded bit, which may complicate the demodulator's design. That is, the demodulator may require coherent demodulation techniques with precise phase estimation and tracking. The phase tracking may not benefit from the coding gain due to separation of demodulation and decoding. Moreover, computing the reliability information may not be trivial for high order modulations (e.g., such as 8PSK and above). Computational complexity at a receiver (e.g., decoding complexity), latency due to decoding operations, and power consumption are all issues in decoding such high-rate TCMs that may be addressed by improved techniques.

The techniques described herein provide for puncturing schemes for TCMs to achieve a higher rate of data transmission, and in some cases may be associated with reduced decoding complexity (e.g., at a receiving device). In some examples, puncturing may be performed at the modulation symbol level (e.g., rather than on a per-encoded bit level), which may enable non-coherent detection schemes at a receiving device (e.g., which may be reliable when the received signal is affected by phase and frequency uncertainties). In other examples, symbols may be effectively punctured even prior to symbol mapping by using puncturing matrices where each column includes either all ones or all zeros. Further, variable rate transmission schemes may be designed to adapt code rates to varying channel conditions (e.g., varying signal and noise conditions). Symbol puncturing techniques and the variable rate transmission schemes described may reduce decoding complexity as the same trellis (e.g., decoder structure) and the same mapping scheme may be used for both punctured rate communications (e.g., higher rate mode) and original rate communications (e.g., non-punctured communications). For example, the puncturing techniques described in more detail below may be applied in high signal-to-noise ratio (SNR) conditions, which may increase transmission rates, and may further enable decoding using a same decoding structure used for original rates. As such, variable rate transmission schemes using the described techniques may beneficially provide for higher data transmission rates and reduced decoding complexity (e.g., reduced decoding structures).

Aspects of the disclosure are initially described in the context of a wireless communications system. Example puncturing scheme implementations and process flows for high-rate TCMs are then described. Aspects of the disclosure are further illustrated by and described with reference to apparatus diagrams, system diagrams, and flowcharts that relate to high-rate trellis coded modulations.

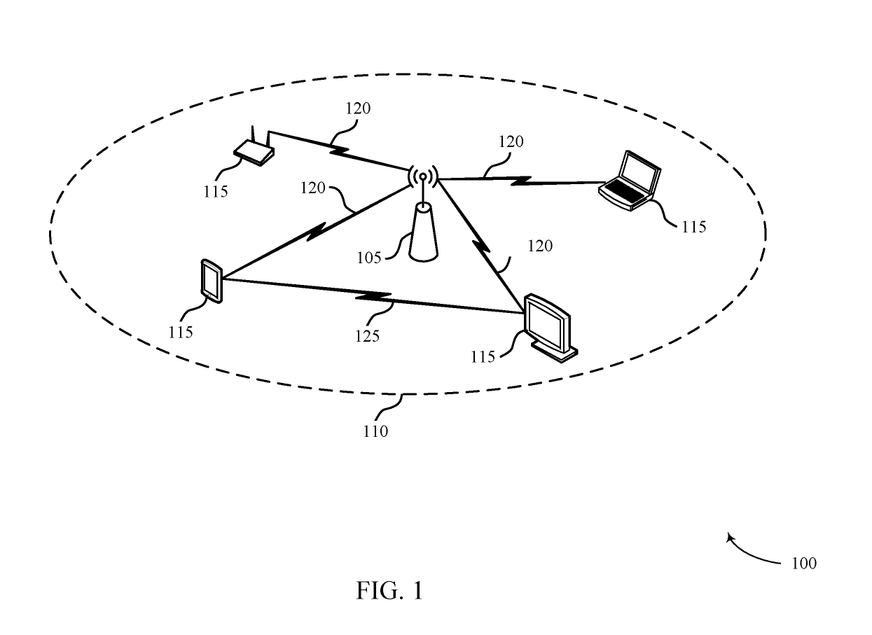

FIG. 1 illustrates a wireless local area network (WLAN) 100 (e.g., a wireless network supporting communications using air interfaces associated with a different radio access technologies (RATs), such as a Bluetooth (BT) RAT, a Zigbee RAT, a Wi-Fi RAT, etc.) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a BSS or an ESS. The various STAs 115 in the network are able to communicate with one another through the AP 105. Also shown is a coverage area 110 of the AP 105, which may represent a BSA of the WLAN 100. An extended network station (not shown) associated with the WLAN 100 may be connected to a wired or wireless distribution system that may allow multiple APs 105 to be connected in an ESS.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The STAs 115 may support communications on a variety of different air interfaces, e.g., BT, Zigbee, cellular, Wi-Fi, etc. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from, e.g., Bluetooth standards (e.g., Bluetooth Core Specifications, Traditional and Generic Attributes Profile Specifications, Protocol Specifications, etc.), IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

Convolutional codes may be used in communications systems to correct for errors in received signals. A terminated convolutional code starts and ends at a known state. While terminated convolutional codes have the benefit of starting and ending at the same known state (e.g., state 0), they also require extra bits to be added, thereby reducing the effective data rate. Tail biting convolutional codes are a type of convolutional code created by cyclic shifting the last few information bits (tail bits) in a convolutional code to the beginning. Accordingly, the tail biting convolutional code starts and ends at the same state (determined by these tail bits) without the impact to data rates of terminated convolutional codes. The Viterbi algorithm, which finds the most likely code word (path), may be used for decoding code words encoded with a terminated convolutional code or tail biting convolutional code. The list Viterbi algorithm further reduces the code word error rate by generating a list of the most likely paths, which are then tested in sequence against an error checking function to select the most likely candidate satisfying the error checking function. In decoding algorithms there may be a relationship between list size, packet error rate, and computational complexity. Increasing the list size may decrease the packet error rate, whereas decreasing the list size may increase the packet error rate. Changing the list size may impact computational complexity. A smaller list size may be associated with less computational complexity, whereas a larger list size may increase computational complexity.

The WLAN 100 may support forward error correction (FEC) for use in improving throughput and reliability in channels with varying SNR. Types of codes used in FEC include convolutional codes, turbo codes, low-density parity check (LDPC) codes, and the like. Generally, the decoder attempts to select a code word with a maximum likelihood of being the code word that was sent, based at least in part on the received symbol information and properties of code words inherent to the encoding scheme. One form of maximum likelihood decoding is Viterbi decoding, which finds the most likely sequence of states given branch metrics associated with state transitions between path nodes. In some cases, a list Viterbi algorithm may be used to generate a list of candidate sequences of states for input to an outer decoder. The outer decoder may perform error checking on the list of candidate sequences, starting from the candidate having the best overall path metric. The first candidate sequence that passes the error checking may be used to output the decoded bit stream. The error checking decoder may perform, for example, a cyclic redundancy check (CRC) on the list of candidate sequences.

With a list size of L, the list Viterbi algorithm may be understood as constructing a trellis over N path nodes, where a list of L candidates is determined for each state of each path node using path metrics from the previous path node and branch metrics associated with the feeding transitions from the feeding states of the previous path node. The feeding transitions for each state of a path node may thus be understood as associated with T·L accumulated path metrics corresponding to each of T feeding states. Selection of the L best accumulated path metrics may be performed by sorting the T·L accumulated path metrics and taking the best L accumulated path metrics as the path metrics for the current path node. However, direct sorting is computationally intensive, generally taking L·log(T·L) cycles per path node, with L·log(T·L)·K total comparisons per path node for a trellis with K states. Thus, improvements in trellis construction for List Viterbi algorithm may improve power consumption and decrease latency in decoding operations for communication devices. A conventional Viterbi algorithm identifies a single best path through the trellis, a List Viterbi algorithm identifies the L best paths, or L best possible outcomes, through the trellis. The Viterbi algorithm, including the List Viterbi algorithm, works for any path metric, whether or not the path metric corresponds to maximum likelihood decoding. For example, the path metric may also be a log likelihood metric, the log a posteriori metric, the Hamming metric, any combination thereof, or the like.

According to various aspects of the disclosure, the devices of WLAN 100 including APs 105 or STAs 115 may be configured for high-rate TCMs and may utilize symbol puncturing techniques discussed herein that do not alter the convolutional code's trellis. In some examples, transmitting devices of WLAN 100 may perform puncturing after convolutionally encoded bits have been mapped to signal constellation points (e.g., symbols). In other examples, transmitting devices of WLAN 100 may effectively puncture symbols prior to symbol mapping by using puncturing matrices where each column includes either all ones or all zeros. Such modulation symbol level puncturing may enable decoding of punctured code rates using a same decoding structure used for original rates (e.g., which may reduce decoding complexity). These variable rate transmission schemes may be designed to adapt code rates to varying channel conditions (e.g., varying signal and noise conditions) without significantly increasing decoding complexity.

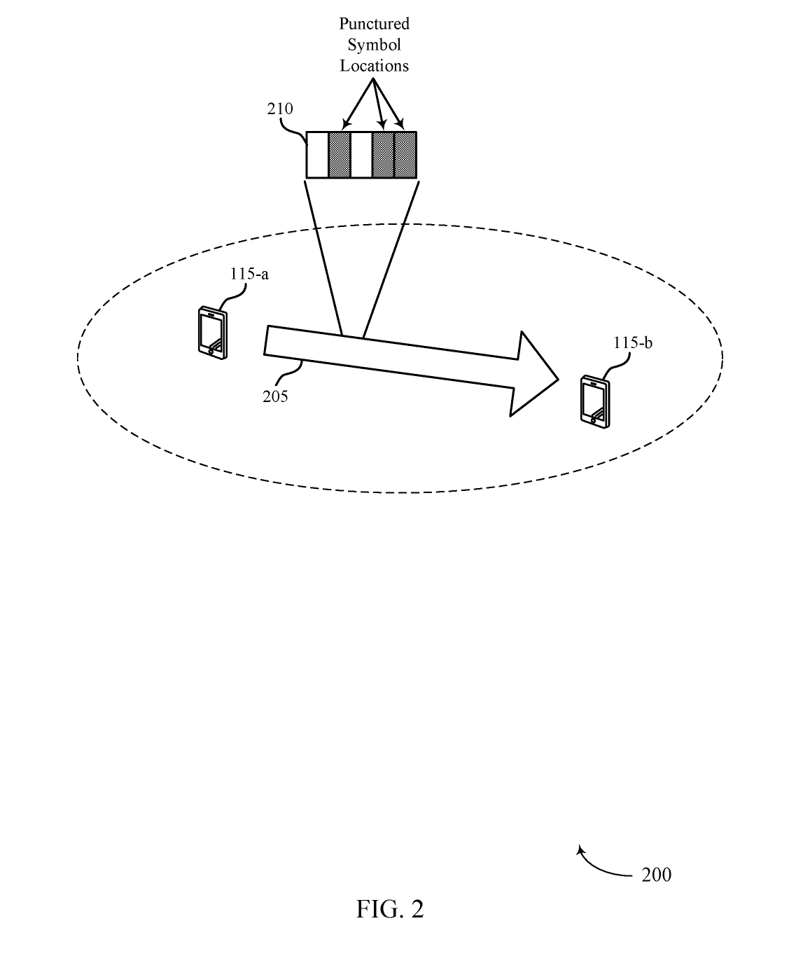

FIG. 2 illustrates an example of a WLAN 200 that supports high-rate TCMs in accordance with aspects of the present disclosure. In some examples, WLAN 200 may implement aspects of WLAN 100. WLAN 200 may include STA 115-a and STA 115-b, which may be examples of STAs 115 as described herein. The WLAN 200 may include a transmitting device (e.g., STA 115-a) that generates, encodes, and transmits data to a receiving device (e.g., STA 115-b) via a communication channel (e.g., such as a wireless communications channel, a digital subscriber line (DSL), etc.). In the depicted example, STA 115-a may be the transmitting device and STA 115-b may be the receiving device. Devices other than STA 115-a and STA 115-b may transmit and receive encoded data. That is, the techniques discussed may be applicable to communications between any transmitting devices such as APs, base stations, STAs, etc.

In some cases, puncturing may be applied after symbol mapping (e.g., on the modulated symbols). That is, encoded bits may be mapped to signal constellation points, and a puncturing matrix may then be applied to the symbols (e.g., symbol locations) associated with the signal constellation points. This may be referred to as symbol puncturing. Symbol puncturing matrices (e.g., a symbol puncturing matrix Pₛ) may include a single row and p columns (e.g., where p is the puncturing period, for example, in symbols). Each column of the p columns may include either a one or a zero, and each column may correspond to one modulated symbol. Columns with a value of zero may show punctured symbol locations (e.g., of symbols that are not transmitted), and columns with a value of one may show symbol locations associated with symbols that are actually transmitted. For example, using p=5, a symbol puncturing matrix

Pₛ=[1 0 1 0 0] (2)

may result in two symbols (e.g., associated with a first and third symbol location in a given symbol puncturing period) being transmitted for every 5 symbols. In general, symbol puncturing matrices may increase transmission rates by

$$\frac{p}{p - l} ,$$

where l is the number of zeros (e.g., punctured symbols) in the puncturing matrix Pₛ. In the example above, the puncturing matrix shown in Equation (2) may increase the coding rate by a factor of 5/2. Assuming the convolutional code rate is k/n, the overall coding rate (e.g., the actual transmission rate or the punctured code rate) becomes

$$R = \frac{kp}{n ( p - l )} .$$

In other examples, the symbol puncturing may be applied prior to the symbol mapping (e.g., prior to mapping encoded bits to modulation symbols). That is, symbols may be effectively punctured by applying a puncturing matrix P (e.g., where each column is either all ones or all zeros), to the encoded bits. As such, the mapping rate may be reduced. For example, the puncturing matrix shown in Equation (2) (e.g., that may be applied after symbol mapping) for a convolutional code with n=3 may be equivalent (e.g., in terms of transmitted symbol locations and punctured symbol locations) to the puncturing matrix

$$P = [ \begin{matrix}{P}_{s} \\ {P}_{s} \\ {P}_{s}\end{matrix} ] = [ \begin{matrix}1 & 0 & 1 & 0 & 0 \\ 1 & 0 & 1 & 0 & 0 \\ 1 & 0 & 1 & 0 & 0\end{matrix} ] \qquad ( 3 )$$

when the puncturing matrix shown above in Equation (3) is applied before symbol mapping.

Decoding of symbol punctured TCMs may be performed using the same decoder used for original (e.g., un-punctured) TCM. The punctured symbols may be replaced with zeros and all variations of Viterbi algorithms (e.g., such as coherent and non-coherent Viterbi algorithms) may be applied to the received samples.

STA 115-a may utilize puncturing schemes discussed above for high-rate TCM transmissions 205 to STA 115-b. Such puncturing schemes that apply puncturing on symbols 210 (e.g., at the modulation symbols level) may decrease decoding complexity at a receiving device (e.g., STA 115-b). STA 115-a may identify puncturing matrices based on a desired punctured code rate (e.g., a desired transmission rate) and further based on whether or not the puncturing is to be applied before or after symbol mapping. For example, STA 115-a may identify or select a puncturing matrix Pₛ if puncturing is to be applied after symbol mapping (e.g., with a single row and a number of p columns corresponding to a puncturing period) or STA 115-a may identify or select a puncturing matrix P if puncturing is to be applied before symbol mapping (e.g., with a number of n rows corresponding to the n coded bits output from the rate-k/n convolutional encoder, and a number of p columns corresponding to a puncturing period). The values within the selected puncturing matrix may be determined based on a desired code rate (e.g., the number of 1 columns with zeros in the puncturing matrix may be selected such that

$$R = \frac{kp}{n ( p - l )}$$

results in the desired transmission rate), SNR conditions (e.g., puncturing matrices providing higher transmission rates may be used in higher SNR environments), which symbol locations are to be punctured or transmitted (e.g., which columns have ones or zeros), etc.

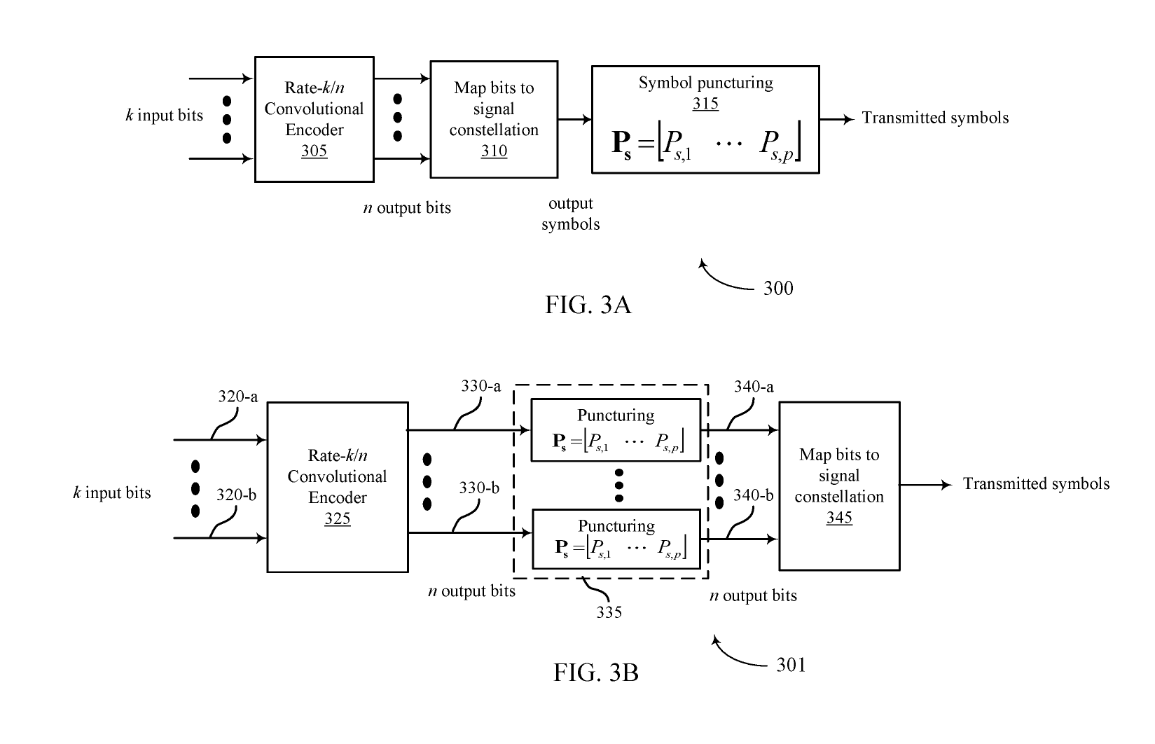

FIGS. 3A and 3B illustrate examples of symbol puncturing implementations 300 and 301 that support high-rate trellis coded modulations in accordance with aspects of the present disclosure. In some examples, symbol puncturing implementation 300 and symbol puncturing implementation 301 may implement aspects of WLAN 100 and WLAN 200. That is, a transmitting AP 105 or a transmitting STA 115 may employ aspects of symbol puncturing implementations 300 and 301 for high-rate TCM transmissions.

In some cases, a generator matrix may be used by an encoder (e.g., a rate-k/n convolutional encoder) to encode information bits input to sub-channels (e.g., sub-channels 320) to generate codeword sub-channels (e.g., sub-channels 330). After encoding, the encoder may, in some examples, pass the encoded bits to a rate-matcher to rate-match the encoded bits to a set of resources for the transmission. The encoder (e.g., or in some cases the rate matcher) may then input the bits to a modulator for symbol modulation prior to the transmission. The transmitting device may then transmit the codeword to a receiving device over a communication channel (e.g., over a wireless channel, a DSL, etc.). In some cases, the sub-channels may be indexed sequentially and each channel index may have a corresponding reliability metric. A first number of sub-channels (e.g., the first 16 channels) may be punctured (i.e., not transmitted) in decoding order. Puncturing a first (lowest index) set of channel indices may be known as unknown bit puncturing or non-shortening based puncturing. Puncturing successive bits may be known as block puncturing. Puncturing may be used for rate matching for a desired code rate or transmitted codeword length. In other examples, shortening based puncturing may be used, which also may be known as known bit puncturing. In shortening based puncturing, a set of channel indices having the highest indexes may be punctured, with corresponding sub-channels set to a known value. However, as discussed above, such puncturing schemes may, in some cases, alter the convolutional code's trellis (e.g., which may increase decoding complexity at a receiver). The following puncturing techniques (e.g., the following puncturing implementation examples) may provide for reduced decoding complexity at a device receiving high-rate (e.g., punctured at the symbol modulation level) TCM transmissions.

The examples of FIGS. 3A and 3B may assume a rate-k/n convolutional encoder and, as discussed in more detail below, a symbol puncturing matrix

Pₛ=[P_{s,1} P_{s,2} . . . P_{s,p}] (4)

may be applied before or after symbol mapping.

In FIG. 3A, symbol puncturing implementation 300 may illustrate puncturing after symbol mapping (e.g., applying the puncturing matrix of Equation (4) to signal constellations or symbols at 310). At 305, information bits may be fed into a rate-k/n encoder (e.g., a rate-k/n convolutional encoder). For example, k input bits (e.g., k information bits) may be fed into the rate-k/n encoder at N bits per second (bps), and the rate-k/n encoder may output n output bits (e.g., n encoded bits). The n encoded bits may then be mapped to signal constellation points at 310. The number of the n encoded bits that may be mapped to a symbol may depend on the signal constellation used (e.g., two bits may be mapped to a single QPSK symbol, three bits may be mapped to a single 8PSK symbol, etc.). At 315, a puncturing matrix (e.g., the puncturing matrix of Equation (4)) may be applied to the symbols (e.g., according to a symbol puncturing periodicity p), which may result in punctured symbols for transmission. For example, n encoded bits may be mapped to several signal constellations (e.g., symbols) at 310, and the several symbols may be punctured according to the puncturing matrix of Equation (4). For a given period of symbols (e.g., for every p symbols generated at 310), symbols associated with columns of the puncturing matrix that have a value of one may be transmitted, while symbols associated with columns of the puncturing matrix that have a value of zero may be punctured. That is, symbol puncturing implementation 300 may illustrate puncturing after symbol mapping with the puncturing matrix of Equation (4).

In FIG. 3B, symbol puncturing implementation 301 may illustrate puncturing before symbol mapping (e.g., applying the puncturing matrix of Equation (4) to each encoded bit stream or each encoded sub-channel 330). At 325, information bits may be fed into sub-channels 320 of a rate-k/n convolutional encoder. For example, k input bits (e.g., k information bits) may be fed into sub-channels (e.g., sub-channel 320-a through sub-channel 320-b) of the encoder at N bps (e.g., in some cases N may depend on the number of sub-channels). The rate-k/n convolutional encoder may output n output bits (e.g., n encoded bits) on sub-channels 330 output from the encoder. The encoded bits on each sub-channel 330 may then be punctured at 335 (e.g., the puncturing matrix of Equation (4) may be applied to each sub-channel 330 output from the encoder). At 345, the punctured set of encoded bits (e.g., punctured bit streams 340) may be mapped to symbols. The number of bits from the punctured bit set (e.g., the number of bits of punctured bit streams 340) that may be mapped to a symbol may depend on the signal constellation used (e.g., two bits may be mapped to a single QPSK symbol, three bits may be mapped to a single 8PSK symbol, etc.). That is, symbol puncturing implementation 301 may illustrate puncturing before symbol mapping with the puncturing matrix of Equation (4).

In some examples, receiving devices may decode the punctured symbols using a same decoding structure used for original rates (e.g., a same decoding structure used for non-punctured symbols). A receiving device may identify a candidate codeword based on a candidate hypothesis (e.g., decoded resources, M:N:K hypothesis). For example, the receiving device may employ a blind decoding process in which multiple candidate hypotheses (i.e., decoding hypotheses) within a search space are tested to determine if decoding performed for any of the candidate hypotheses is successful. A receiving device may include a demodulator to demodulate the candidate codeword, which may include demapping received symbols associated with a set of resources to obtain a representation of the codeword. The demodulator may then pass the representation of the codeword to a decoder of the receiving device to identify the most likely candidate path or paths for the information bits obtained from the codeword. The demodulated signal may be, for example, a sequence of logarithmic-likelihood ratio (LLR) values representing a probability value of a received bit being a ‘0’ or a ‘1.’ The decoder may, in some examples, perform a list decoding algorithm on the LLR values and may provide an output. If the decoder is able to decode the encoded codeword successfully, the decoder may output a bit sequence of the information vector (e.g., the k information bits) for use, storage, communication to another device, or the like. Further, the decoding structure used by the receiving device for punctured symbols may be the same decoding structure used for original un-punctured symbol reception.

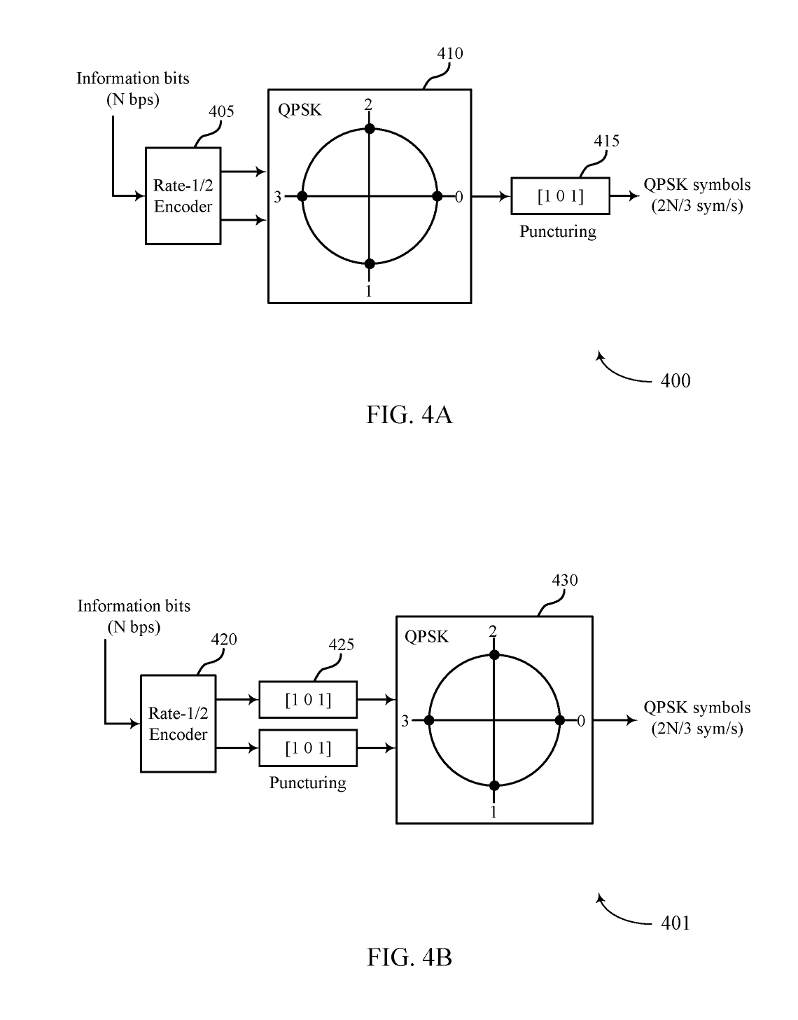

FIGS. 4A and 4B illustrate examples of rate-3/4 coded QPSK symbol puncturing implementations 400 and 401 that support high-rate trellis coded modulations in accordance with aspects of the present disclosure. In some examples, rate-3/4 coded QPSK symbol puncturing implementation 400 and rate-3/4 coded QPSK symbol puncturing implementation 401 may implement aspects of WLAN 100 and WLAN 200. That is, a transmitting AP 105 or a transmitting STA 115 may employ aspects of QPSK symbol puncturing implementations 400 and 401 for high-rate TCM transmissions.

The examples of FIGS. 4A and 4B may assume a rate-½ convolutional encoder, where a transmission code rate (e.g., a punctured code rate) of 3/4 of an uncoded QPSK system (e.g., a rate-3/4 coded QPSK) is desired. As discussed in more detail below, symbol puncturing matrices used to achieve such a rate-3/4 coded QPSK may include

$$\begin{matrix}{P}_{s} = [ 1 \; 0 \; 1 ] & ( 5 ) \\ and , & \\ P = [ \begin{matrix}{P}_{s} \\ {P}_{s}\end{matrix} ] = [ \begin{matrix}1 & 0 & 1 \\ 1 & 0 & 1\end{matrix} ] & ( 6 )\end{matrix}$$

depending on where the puncturing is applied (e.g., whether the puncturing matrix is applied before or after symbol mapping). The symbol puncturing matrices of Equation (5) and Equation (6) may result in transmission of two QPSK symbols (e.g., where two encoded bits are mapped to each QPSK symbol) for every three information bits, which results in a transmission rate of 3/4 of an uncoded QPSK system. The encoder (e.g., the underlying convolutional encoder) may be any rate 1/2 code. As one example, an encoder associated with a [23,35] generator polynomial in octal format may be implemented.

In FIG. 4A, rate-3/4 coded QPSK symbol puncturing implementation 400 may illustrate puncturing after symbol mapping (e.g., applying the puncturing matrix of Equation (5) to QPSK symbols at 415). At 405, information bits may be fed into a rate-1/2 encoder (e.g., a rate-1/2 convolutional encoder). For example, k input bits (e.g., k information bits) may be fed into the rate-1/2 encoder at N bps, and the rate-1/2 encoder may output n output bits (e.g., n encoded bits), where k/n is 1/2. The n encoded bits may then be mapped to signal constellation points at 410. For example, for every one input bit fed into the rate-1/2 encoder at 405, two encoded bits may be mapped to a single QPSK symbol at 410. At 415, a puncturing matrix (e.g., the puncturing matrix of Equation (5)) may be applied to QPSK symbols (e.g., according to a puncturing periodicity of three QPSK symbols), which may result in punctured QPSK symbols for transmission at a rate of 2N/3 QPSK symbols per second (e.g., where N is the bps of information bits fed into the encoder). That is, rate-3/4 coded QPSK symbol puncturing implementation 400 may illustrate puncturing after symbol mapping with the puncturing matrix of Equation (5), which may result in rate-3/4 coded QPSK and 2N/3 QPSK symbols per second.

In FIG. 4B, rate-3/4 coded QPSK symbol puncturing implementation 401 may illustrate puncturing before symbol mapping (e.g., applying the puncturing matrix of Equation (6) to encoded bit streams or encoded sub-channels at 425). At 420, information bits may be fed into a rate-1/2 encoder (e.g., a rate-1/2 convolutional encoder). For example, k input bits (e.g., k information bits) may be fed into the rate-1/2 encoder at N bps, and the rate-1/2 encoder may output n output bits (e.g., n encoded bits), where k/n is 1/2. The n encoded bits may then be punctured at 425 (e.g., the puncturing matrix of Equation (6) may be applied to the encoded bits). Note that applying the puncturing matrix of Equation (6) to the encoded bits may be equivalent to applying the puncturing matrix of Equation (5) to each encoded bit stream or each sub-channel output from the encoder at 420. At 430, the punctured set of encoded bits may be mapped to QPSK symbols, which may result in punctured QPSK symbols for transmission at a rate of 2N/3 QPSK symbols per second (e.g., where N is the bps of information bits fed into the encoder). That is, rate-3/4 coded QPSK symbol puncturing implementation 401 may illustrate puncturing before symbol mapping with the puncturing matrix of Equation (6), which may result in rate-3/4 coded QPSK and 2N/3 QPSK symbols per second.

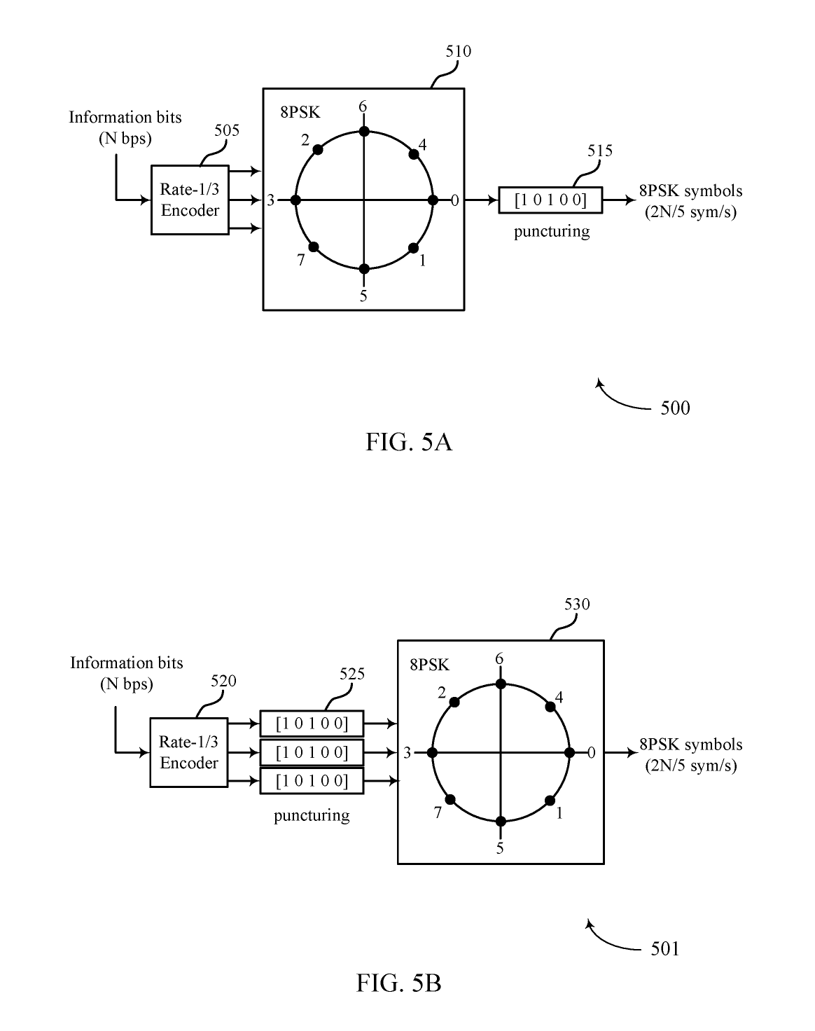

FIGS. 5A and 5B illustrate examples of rate-5/6 coded 8PSK symbol puncturing implementations 500 and 501 that support high-rate trellis coded modulations in accordance with aspects of the present disclosure. In some examples, rate-5/6 coded 8PSK symbol puncturing implementation 500 and rate-5/6 coded 8PSK symbol puncturing implementation 501 may implement aspects of WLAN 100 and WLAN 200. That is, a transmitting AP 105 or a transmitting STA 115 may employ aspects of 8PSK symbol puncturing implementations 500 and 501 for high-rate TCM transmissions.

The examples of FIGS. 5A and 5B may assume a rate 1/3 convolutional encoder, where a transmission code rate (e.g., a punctured code rate) of 5/6 for an 8PSK system (e.g., a rate-5/6 coded 8PSK) is desired. As discussed in more detail below, symbol puncturing matrices used to achieve such a rate-5/6 coded 8PSK may include

$$\begin{matrix}{P}_{s} = [ 1 \; 0 \; 1 \; 0 \; 0 ] & ( 7 ) \\ and , & \\ P = [ \begin{matrix}{P}_{s} \\ {P}_{s} \\ {P}_{s}\end{matrix} ] = [ \begin{matrix}1 & 0 & 1 & 0 & 0 \\ 1 & 0 & 1 & 0 & 0 \\ 1 & 0 & 1 & 0 & 0\end{matrix} ] & ( 8 )\end{matrix}$$

depending on where the puncturing is applied (e.g., whether the puncturing matrix is applied before or after symbol mapping). The symbol puncturing matrices of Equation (7) and Equation (8) may result in transmission of two 8PSK symbols (e.g., where three encoded bits are mapped to each 8PSK symbol) for every five information bits, which results in a transmission rate of 5/6 of a coded 8PSK system. The encoder (e.g., the underlying convolutional encoder) may be any rate 1/3 code. As one example, an encoder associated with a [23,33,37] generator polynomial in octal format may be implemented.

In FIG. 5A, rate-5/6 coded 8PSK symbol puncturing implementation 500 may illustrate puncturing after symbol mapping (e.g., applying the puncturing matrix of Equation (7) to 8PSK symbols at 515). At 505, information bits may be fed into a rate-1/3 encoder (e.g., a rate-1/3 convolutional encoder). For example, k input bits (e.g., k information bits) may be fed into the rate-1/3 encoder at N bps, and the rate-1/3 encoder may output n output bits (e.g., n encoded bits), where k/n is 1/3. The n encoded bits may then be mapped to signal constellation points at 510. For example, for every one input bit fed into the rate-1/3 encoder at 505, three encoded bits may be mapped to a single 8PSK symbol at 510. At 515, a puncturing matrix (e.g., the puncturing matrix of Equation (7)) may be applied to 8PSK symbols (e.g., according to a puncturing periodicity of five 8PSK symbols), which may result in punctured 8PSK symbols for transmission at a rate of 2N/5 8PSK symbols per second (e.g., where N is the bps of information bits fed into the encoder). That is, rate-5/6 coded 8PSK symbol puncturing implementation 500 may illustrate puncturing after symbol mapping with the puncturing matrix of Equation (7), which may result in rate-5/6 coded 8PSK and 2N/5 8PSK symbols per second.

In FIG. 5B, rate-5/6 coded 8PSK symbol puncturing implementation 501 may illustrate puncturing before symbol mapping (e.g., applying the puncturing matrix of Equation (8) to encoded bit streams or encoded sub-channels at 525). At 520, information bits may be fed into a rate-1/3 encoder (e.g., a rate-1/3 convolutional encoder). For example, k input bits (e.g., k information bits) may be fed into the rate-1/3 encoder at N bps, and the rate-1/3 encoder may output n output bits (e.g., n encoded bits), where k/n is 1/3. The n encoded bits may then be punctured at 525 (e.g., the puncturing matrix of Equation (8) may be applied to the encoded bits). Note that applying the puncturing matrix of Equation (8) to the encoded bits may be equivalent to applying the puncturing matrix of Equation (7) to each encoded bit stream or each sub-channel output from the encoder at 520. At 530, the punctured set of encoded bits may be mapped to 8PSK symbols, which may result in punctured 8PSK symbols for transmission at a rate of 2N/5 8PSK symbols per second (e.g., where N is the bps of information bits fed into the encoder). That is, rate-5/6 coded 8PSK symbol puncturing implementation 501 may illustrate puncturing before symbol mapping with the puncturing matrix of Equation (8), which may result in rate-5/6 coded 8PSK and 2N/5 8PSK symbols per second.

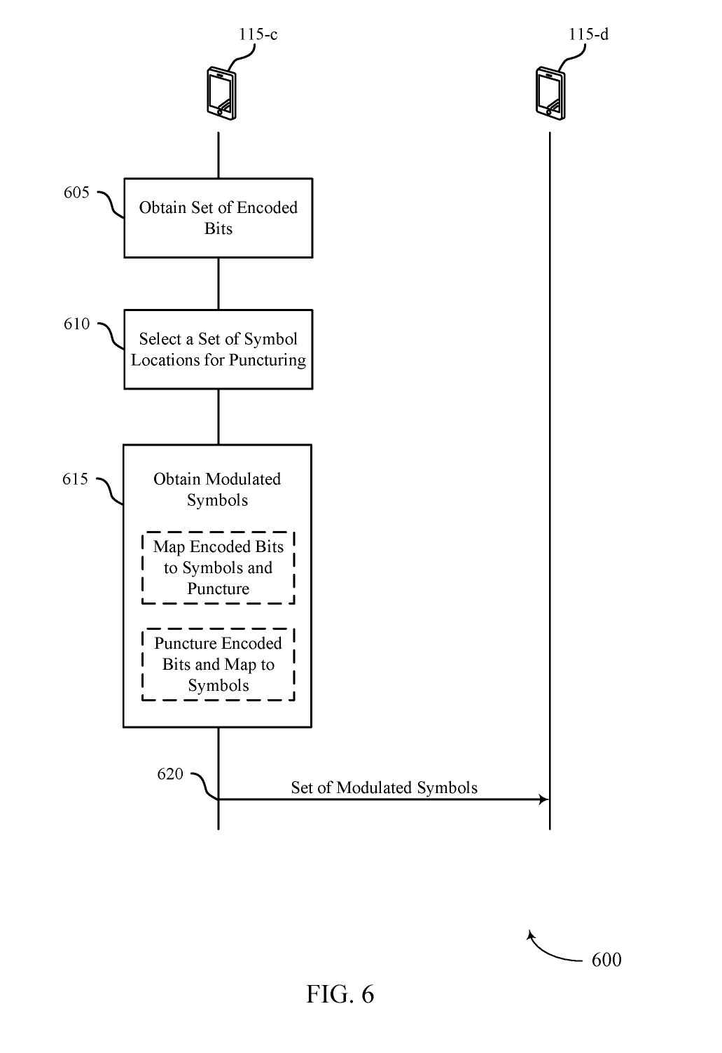

FIG. 6 illustrates an example of a process flow 600 that supports high-rate trellis coded modulations in accordance with aspects of the present disclosure. In some examples, process flow 600 may implement aspects of WLAN 100 and WLAN 200. Process flow 600 may include STA 115-c and STA 115-d, which may implement aspects of techniques described with reference to FIGS. 1-5. In the depicted example, STA 115-c may be the transmitting device and STA 115-d may be the receiving device. Devices other than STA 115-c and STA 115-d may transmit and receive encoded data. That is, the techniques discussed may be applicable to communications between any transmitting devices such as APs, base stations, STAs, etc.

At 605, STA 115-c may obtain a set of encoded bits by encoding a set of input bits according to a convolutional code. For example, STA 115-c may select a convolutional code rate, where the convolutional code rate includes a ratio of a number of the set of input bits and a number of the set of encoded bits (e.g., STA 115-c may select some k/n convolutional code rate). That is, STA 115-c may select a convolutional code rate and encode the set of input bits to obtain the set of encoded bits (e.g., the STA 115-c may encode the set of input bits based on the selected convolutional code rate).

At 610, STA 115-c may select a set of symbol locations based at least in part on a puncturing matrix. Each symbol location of the selected set of symbol locations may correspond to a plurality of encoded bits of the set of encoded bits obtained at 605. For example, STA 115-c may select a punctured code rate and identify the puncturing matrix based on the selected punctured code rate and the convolutional code rate. The identified puncturing matrix may then be applied to the encoded bits before symbol mapping, or alternatively may be applied to the symbols after mapping, as discussed herein. In some cases, the puncturing matrix may be identified based on the convolutional code rate and a symbol puncturing periodicity.

At 615, STA 115-c may obtain a set of modulated symbols by mapping, for each symbol location of the set of symbol locations selected at 610, the plurality of encoded bits corresponding to that symbol location to a signal constellation point. As discussed above, the modulated symbols may be obtained by mapping the encoded bits to symbols and applying the puncturing matrix to the symbols, or the modulated symbols may be obtained by applying the puncturing matrix to the encoded bits and mapping the resulting bits to symbols. For example, the encoded bits obtained at 605 may be punctured (e.g., via a puncturing matrix identified by STA 115-c) and the punctured encoded bits may be mapped to the set of modulated symbols (e.g., the modulated symbols may be obtained by mapping the punctured set of encoded bits to signal constellation points). Alternatively, selecting the set of symbol locations at 610 may include mapping the set of encoded bits (e.g., obtained at 605) to a plurality of symbols, and puncturing the plurality of symbols based on a puncturing matrix identified by STA 115-c (e.g., the set of symbol locations may be selected based on the puncturing). That is, STA 115-c may select a set of symbol locations for puncturing, and a puncturing matrix may be identified based on a desired punctured code rate and further based on whether or not the puncturing is to be applied before or after symbol mapping (e.g., a puncturing matrix may have more than one row in cases where the encoded bits are punctured prior to symbol mapping, where each column is associated with either all ones or all zeros).

The puncturing matrix may include a number of columns (e.g., based on some symbol puncturing periodicity, a puncturing period, etc.) and the values within each column may be set according to a selected punctured code rate and a selected convolutional code rate. For example, the identified puncturing matrix may include a plurality of columns including a first column and a second column, where each value of the first column may include a first same value (e.g., each value may be set to 1) and each value of the second column may include a second same value (e.g., each value may be set to 0). In such an example, the set of modulated symbols may include at least the first column based on the column values being set to 1, and a set of punctured symbol locations may include at least the second column based on the column values being set to 0 (e.g., the set of modulated symbols may correspond to symbol locations associated with columns of the puncturing matrix that are set to 1, while columns of the puncturing matrix set to 0 may be associated with a punctured symbol location).

As another example, STA 115-c may select a punctured code rate of 3/4 (e.g., a rate-3/4 coded QPSK) and a convolutional code rate of 1/2. To achieve such a punctured code rate, a puncturing matrix may be identified (e.g., the puncturing matrix of Equation (5)) with a plurality of columns including a first column, a second column, and a third column. Each value of the first column and the third column may include a first same value (e.g., each value of the first and third column may be 1) and each value of the second column may include a second same value (e.g., each value of the second column may be 0). The set of modulated symbols may thus include symbol locations associated with the first and third columns of the identified puncturing matrix (e.g., the puncturing matrix may puncture symbol locations associated with the second column).

At another example, STA 115-c may select a punctured code rate of 5/6 (e.g., a rate-5/6 coded 8PSK) and a convolutional code rate of 1/3. To achieve such a punctured code rate, a puncturing matrix may be identified with a plurality of columns including a first column, a second column, a third column, a fourth column, and a fifth column. Each value of the first column and the third column may include a first same value (e.g., each value of the first and third column may be 1) and each value of the second column, the fourth column, and the fifth column may include a second same value (e.g., each value of the second, fourth, and fifth columns may be 0). The set of modulated symbols may thus include symbol locations associated with the first and third columns of the identified puncturing matrix (e.g., the puncturing matrix may puncture symbol locations associated with the second, fourth, and fifth columns).

At 620, STA 115-c may transmit the set of modulated symbols obtained at 615 to STA 115-d (e.g., over a DSL, a wireless channel, etc.).

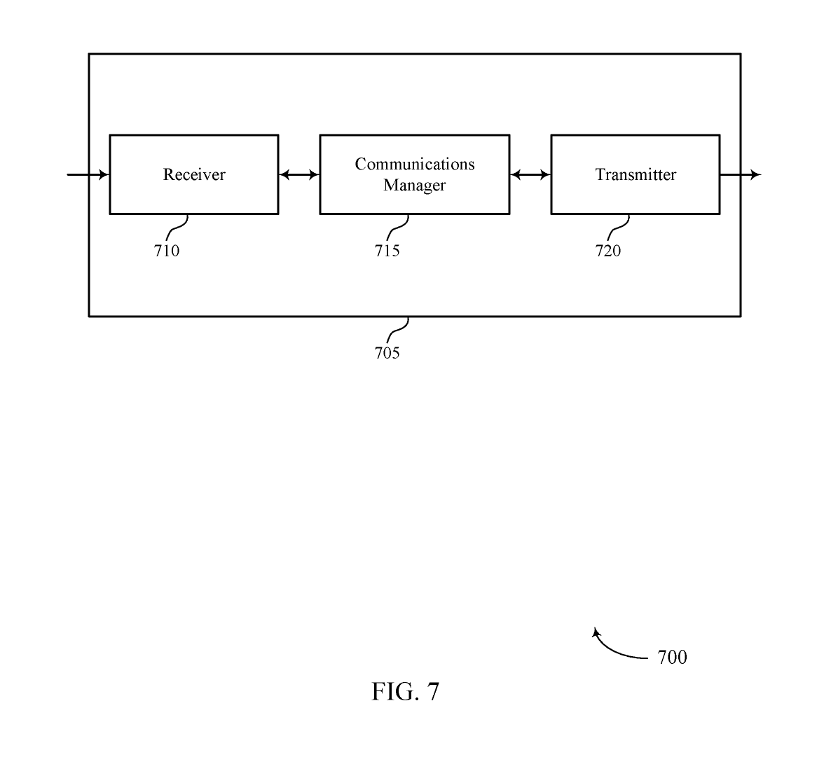

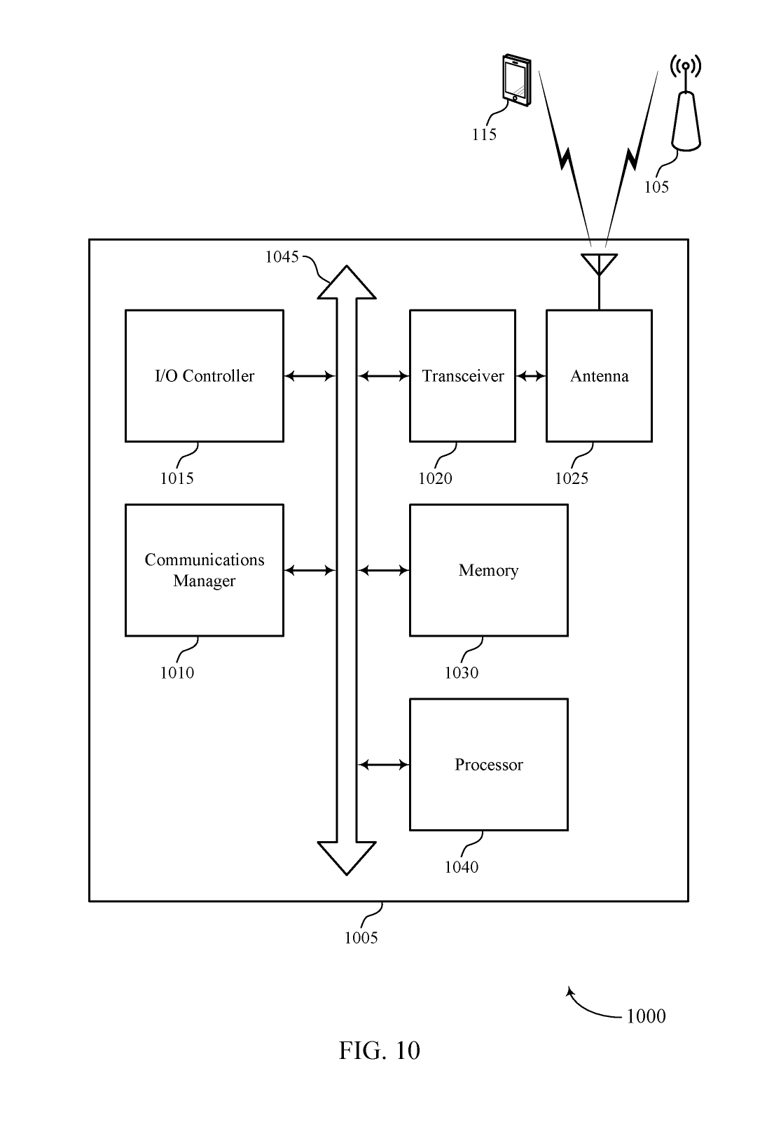

FIG. 7 shows a block diagram 700 of a transceiver 705 that supports high-rate trellis coded modulations in accordance with aspects of the present disclosure. The transceiver 705 may be an example of aspects of a device (e.g., a STA 115 or an AP 105) as described herein (e.g., transceiver 705 may be an example of aspects of the transceiver 1020 described with reference to FIG. 10). The transceiver 705 may include a receiver 710, a communications manager 715, and a transmitter 720. In some cases, the communications manager 715 may be referred to as a modem. For example, the communications manager 715 may modulate packets and provide the modulated packets to the transmitter 720 (e.g., to antenna circuitry for transmission), and may demodulate packets received from the receiver 710 (e.g., from antenna circuitry of the receiver). The transceiver 705 may also include a processor (e.g., a baseband processing chip). Each of these components may be in communication with one another (e.g., via one or more buses).

Receiver 710 may receive information such as packets, user data, or control information associated with various information channels (e.g., control channels, data channels, and information related to trigger-based state switch signaling, etc.). Information may be passed on to other components of the device (e.g., to communications manager 715). The receiver 710 may be an example of aspects of the transceiver 1020 or antenna 1025 described with reference to FIG. 10. The receiver 710 may utilize a single antenna or a set of antennas. In some cases, receiver 710 may refer to receiver circuitry used to convert (e.g., translate) a radio frequency (RF) signal to an analog baseband signal. The receiver 710 may pass the analog baseband signal to an analog-to-digital converter (ADC) and the communications manager 715 may demodulate the received packets.

The communications manager 715 may obtain a set of encoded bits by encoding a set of input bits according to a convolutional code and select a set of symbol locations based on a puncturing matrix. Each symbol location of the selected set of symbol locations may correspond to a set of encoded bits of the set of encoded bits. Communications manager 715 may obtain a set of modulated symbols by mapping, for each symbol location of the selected set of symbol locations, the set of encoded bits corresponding to that symbol location to a signal constellation point. Communications manager 715 may transmit the set of modulated symbols over a communications channel (e.g., over a wireless channel). The communications manager 715 may be an example of aspects of the communications manager 1010 described with reference to FIG. 10.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Transmitter 720 may transmit signals generated by other components of the device. For example, communications manager 715 may modulate the packets as described above, and may provide the modulated packets to the transmitter 720 (e.g., to antenna circuitry for transmission). The transmitter 720 may be an example of aspects of the antenna 1025 or transceiver 1020 described with reference to FIG. 10. The transmitter 720 may utilize a single antenna or a set of antennas

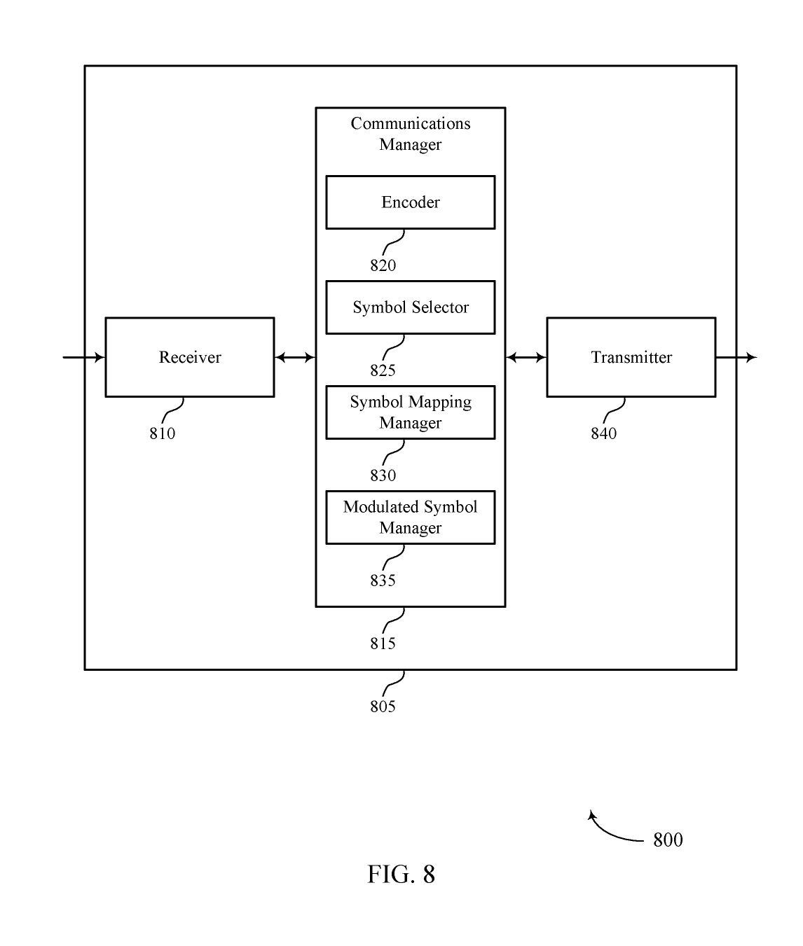

FIG. 8 shows a block diagram 800 of a transceiver 805 that supports high-rate trellis coded modulations in accordance with aspects of the present disclosure. The transceiver 805 may be an example of aspects of a transceiver 705 or aspects of a device (e.g., an AP 105 or a STA 115) as described with reference to FIGS. 1 and 7. The transceiver 805 may include a receiver 810, a communications manager 815, and an transmitter 840. In some cases, the communications manager 815 may be referred to as a modem. For example, communications manager 815 may modulate packets and provide the modulated packets to the transmitter 840 (e.g., to antenna circuitry for transmission), and may demodulate packets received from the receiver 810 (e.g., from antenna circuitry of the receiver). The transceiver 805 may also include a processor (e.g., a baseband processing chip). Each of these components may be in communication with one another (e.g., via one or more buses).

Receiver 810 may receive information such as packets, user data, or control information associated with various information channels (e.g., control channels, data channels, and information related to trigger-based state switch signaling, etc.). Information may be passed on to other components of the device (e.g., to communications manager 815). The receiver 810 may be an example of aspects of the transceiver 1020 or antenna 1025 described with reference to FIG. 10. The receiver 810 may utilize a single antenna or a set of antennas. In some cases, receiver 810 may refer to receiver circuitry used to convert (e.g., translate) a RF signal to an analog baseband signal. The receiver 810 may pass the analog baseband signal to a ADC and the communications manager 815 may demodulate the received packets.

The communications manager 815 may include an encoder 820, a symbol selector 825, a symbol mapping manager 830, and a modulated symbol manager 835. The communications manager 815 may be an example of aspects of the communications manager 1010 described with reference to FIG. 10.

The encoder 820 may obtain a set of encoded bits by encoding a set of input bits according to a convolutional code. The symbol selector 825 may select a set of symbol locations based on a puncturing matrix, where each symbol location of the selected set of symbol locations corresponds to a set of encoded bits of the set of encoded bits. The symbol mapping manager 830 may obtain a set of modulated symbols by mapping, for each symbol location of the selected set of symbol locations, the set of encoded bits corresponding to that symbol location to a signal constellation point. The modulated symbol manager 835 may transmit the set of modulated symbols over a communications channel (e.g., over a wireless channel).

Transmitter 840 may transmit signals generated by other components of the device. For example, communications manager 815 may modulate the packets as described above, and may provide the modulated packets to the transmitter 840 (e.g., to antenna circuitry for transmission). In some examples, the transmitter 840 may be collocated with a receiver 810 in a transceiver module. For example, the transmitter 840 may be an example of aspects of the antenna 1025 or transceiver 1020 described with reference to FIG. 10. The transmitter 840 may utilize a single antenna or a set of antennas.

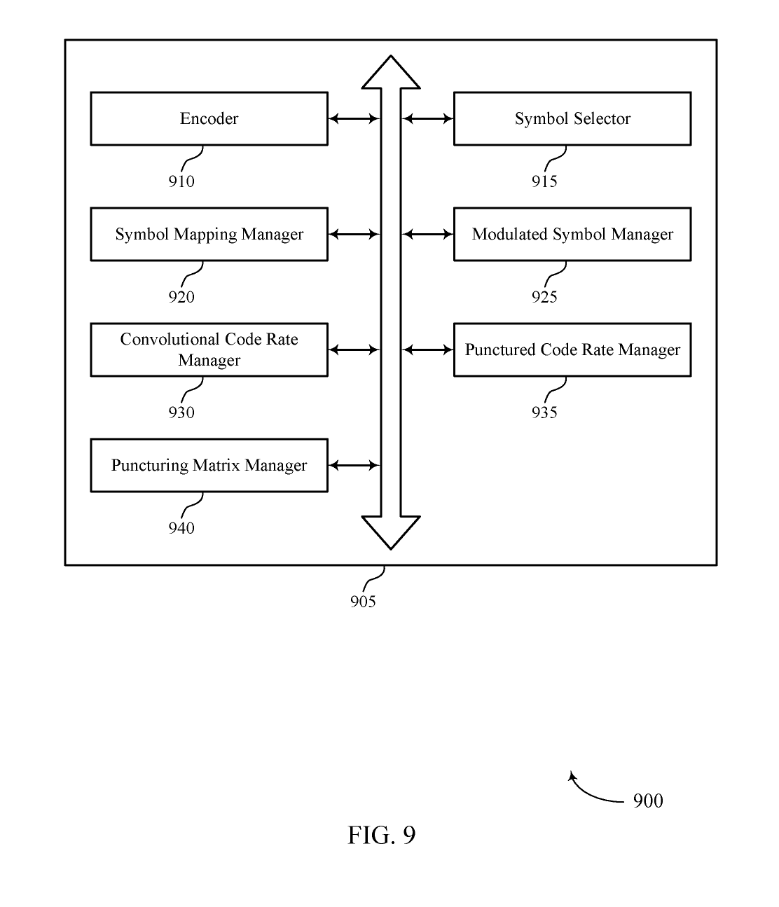

FIG. 9 shows a block diagram 900 of a communications manager 905 that supports high-rate trellis coded modulations in accordance with aspects of the present disclosure. The communications manager 905 may be an example of aspects of a communications manager 715, a communications manager 815, or a communications manager 1010 described with reference to FIGS. 7, 8, and 10. The communications manager 905 may include an encoder 910, a symbol selector 915, a symbol mapping manager 920, a modulated symbol manager 925, a convolutional code rate manager 930, a punctured code rate manager 935, and a puncturing matrix manager 940. Each of these modules may communicate, directly or indirectly, with one another (e.g., via one or more buses).

The encoder 910 may obtain a set of encoded bits by encoding a set of input bits according to a convolutional code. In some examples, the encoder 910 may encode the set of input bits to obtain the set of encoded bits based on the selected convolutional code rate. The symbol selector 915 may select a set of symbol locations based on a puncturing matrix, where each symbol location of the selected set of symbol locations corresponds to a set of encoded bits of the set of encoded bits.

The symbol mapping manager 920 may obtain a set of modulated symbols by mapping, for each symbol location of the selected set of symbol locations, the set of encoded bits corresponding to that symbol location to a signal constellation point. In some examples, the symbol mapping manager 920 may map the set of encoded bits to a set of symbols. In some examples, the symbol mapping manager 920 may puncture the set of symbols based on the puncturing matrix, where the set of symbol locations is selected based on the puncturing. The modulated symbol manager 925 may transmit the set of modulated symbols over a communications channel.

The convolutional code rate manager 930 may select a convolutional code rate, where the convolutional code rate includes a ratio of a number of the set of input bits and a number of the set of encoded bits. The punctured code rate manager 935 may select a punctured code rate. The puncturing matrix manager 940 may identify the puncturing matrix based on the selected punctured code rate and the convolutional code rate. In some examples, the puncturing matrix manager 940 may puncture the set of encoded bits based on the identified puncturing matrix, where the mapping of the set of modulated symbols is based on the punctured set of encoded bits. In some cases, the puncturing matrix is identified based on the convolutional code rate and a symbol puncturing periodicity. In some cases, the identified puncturing matrix includes a plurality of columns including a first column and a second column, where each value of the first column includes a first same value and each value of the second column includes a second same value. In some cases, a number of the set columns is based on a puncturing period.

In some cases, the first same value is a one and the second same value is a zero, and where the set of modulated symbols includes at least the first column based on the first same value and a set of punctured symbol locations includes at least the second column based on the second same value. In some cases, the plurality of columns includes the first column, the second column, and a third column, where each value of the first column and the second column includes is a one and each value of the third column is a zero. In some cases, the plurality of columns may include the first column, the second column, and a third column, where each value of the second column and the third column may be a one and each value of the first column may be a zero. In some cases, the plurality of columns may include the first column, the second column, and a third column, where each value of the first column and the third column may be a one and each value of the second column may be a zero. In some cases, the selected punctured code rate is 3/4 and the convolutional code rate is 1/2, and where the plurality of columns includes the first column, the second column, and a third column, where each value of the first column and the third column includes a first same value and each value of the second column includes a second same value. In some cases, the first same value is a one and the second same value is a zero, and where the set of modulated symbols includes at least the first column and the third column based on the first same value and a set of punctured symbol locations includes the second column based on the second same value.

In some cases, the selected punctured code rate is 5/6 and the convolutional code rate is 1/3, and where the plurality of columns includes the first column, the second column, a third column, a fourth column, and a fifth column, where each value of the first column and the third column includes a first same value and each value of the second column, the fourth column, and the fifth column includes a second same value.

In some cases, the first same value is a one and the second same value is a zero, and where the set of modulated symbols includes at least the first column and the third column based on the first same value and a set of punctured symbol locations includes the second column, the fourth column, and the fifth column based on the second same value.

FIG. 10 shows a diagram of a system 1000 including a device 1005 that supports high-rate trellis coded modulations in accordance with aspects of the present disclosure. The device 1005 may be an example of or include the components of device 705, device 805, or a device (e.g., a STA 115, an AP 105, etc.) as described above, e.g., with reference to FIGS. 1, 7 and 8. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

I/O controller 1015 may manage input and output signals for device 1005. I/O controller 1015 may also manage peripherals not integrated into device 1005. In some cases, I/O controller 1015 may represent a physical connection or port to an external peripheral. In some cases, I/O controller 1015 may utilize an operating system such as iOS®, ANDROID®, MS-DOS®, MS-WINDOWS®, OS/2®, UNIX®, LINUX®, or another known operating system. In other cases, I/O controller 1015 may represent or interact with a modem, a keyboard, a mouse, a touchscreen, or a similar device. In some cases, I/O controller 1015 may be implemented as part of a processor. In some cases, a user may interact with device 1005 via I/O controller 1015 or via hardware components controlled by I/O controller 1015.

Transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions. The wireless device may communicate with other STAs 115 and/or other APs 105 via antenna 1025.

Memory 1030 may include RAM and ROM. The memory 1030 may store computer-readable, computer-executable software 1035 including instructions that, when executed, cause the processor to perform various functions described herein. In some cases, the memory 1030 may contain, among other things, a BIOS which may control basic hardware or software operation such as the interaction with peripheral components or devices.

Processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1040 may be configured to operate a memory array using a memory controller. In other cases, a memory controller may be integrated into processor 1040. Processor 1040 may be configured to execute computer-readable instructions stored in a memory to perform various functions (e.g., functions or tasks supporting high-rate trellis coded modulations).

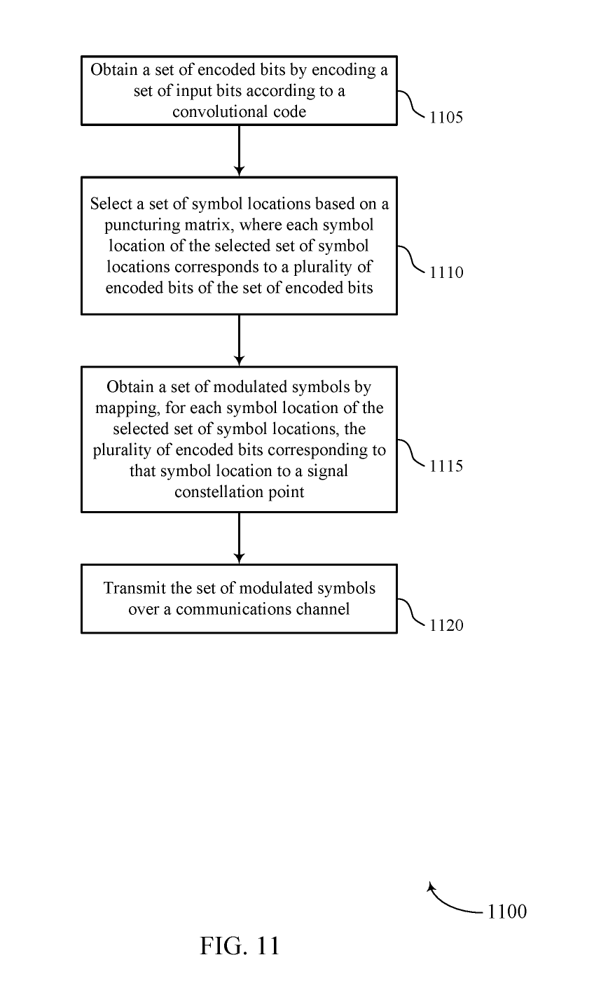

FIG. 11 shows a flowchart illustrating a method 1100 that supports high-rate trellis coded modulations in accordance with aspects of the present disclosure. The operations of method 1100 may be implemented by a device or its components as described herein. For example, the operations of method 1100 may be performed by a communications manager as described with reference to FIGS. 7 to 10. In some examples, a device may execute a set of instructions to control the functional elements of the device to perform the functions described below. Additionally or alternatively, a device may perform aspects of the functions described below using special-purpose hardware.

At 1105, the device may obtain a set of encoded bits by encoding a set of input bits according to a convolutional code. The operations of 1105 may be performed according to the methods described herein. In some examples, aspects of the operations of 1105 may be performed by an encoder as described with reference to FIGS. 7 to 10.

At 1110, the device may select a set of symbol locations based at least in part on a puncturing matrix, where each symbol location of the selected set of symbol locations corresponds to a plurality of encoded bits of the set of encoded bits. The operations of 1110 may be performed according to the methods described herein. In some examples, aspects of the operations of 1110 may be performed by a symbol selector as described with reference to FIGS. 7 to 10.

At 1115, the device may obtain a set of modulated symbols by mapping, for each symbol location of the selected set of symbol locations, the plurality of encoded bits corresponding to that symbol location to a signal constellation point. The operations of 1115 may be performed according to the methods described herein. In some examples, aspects of the operations of 1115 may be performed by a symbol mapping manager as described with reference to FIGS. 7 to 10.

At 1120, the device may transmit the set of modulated symbols over a communications channel (e.g., over a wireless channel, a DSL, etc.). The operations of 1120 may be performed according to the methods described herein. In some examples, aspects of the operations of 1120 may be performed by a modulated symbol manager as described with reference to FIGS. 7 to 10.

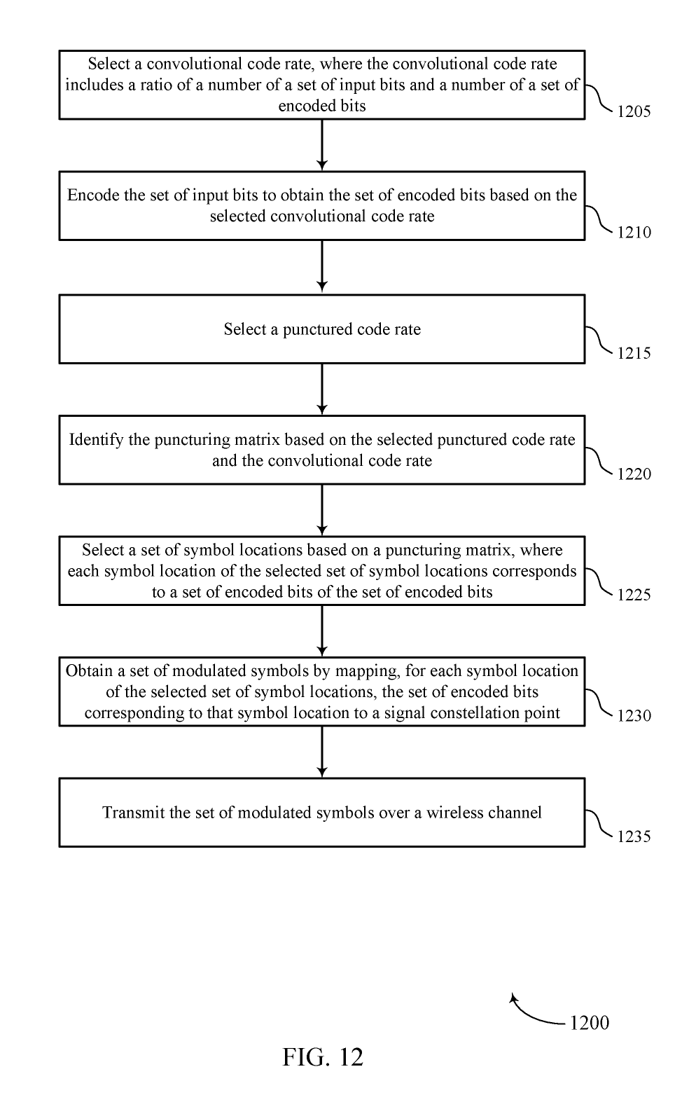

FIG. 12 shows a flowchart illustrating a method 1200 that supports high-rate trellis coded modulations in accordance with aspects of the present disclosure. The operations of method 1200 may be implemented by a device or its components as described herein. For example, the operations of method 1200 may be performed by a communications manager as described with reference to FIGS. 7 to 10. In some examples, a device may execute a set of instructions to control the functional elements of the device to perform the functions described below. Additionally or alternatively, a device may perform aspects of the functions described below using special-purpose hardware.

At 1205, the device may select a convolutional code rate, where the convolutional code rate may include a ratio of a number of a set of input bits and a number of a set of encoded bits. The operations of 1205 may be performed according to the methods described herein. In some examples, aspects of the operations of 1205 may be performed by an encoder as described with reference to FIGS. 7 to 10.

At 1210, the device may encode the set of input bits to obtain the set of encoded bits based at least in part on the selected convolutional code rate to obtain the set of encoded bits by encoding the set of input bits according to the selected convolutional code. The operations of 1210 may be performed according to the methods described herein. In some examples, aspects of the operations of 1210 may be performed by a convolutional code rate manager as described with reference to FIGS. 7 to 10.

At 1215, the device may select a punctured code rate. The operations of 1220 may be performed according to the methods described herein. In some examples, aspects of the operations of 1220 may be performed by a punctured code rate manager as described with reference to FIGS. 7 to 10.

At 1220, the device may identify the puncturing matrix based at least in part on the selected punctured code rate and the convolutional code rate. The operations of 1225 may be performed according to the methods described herein. In some examples, aspects of the operations of 1225 may be performed by a puncturing matrix manager as described with reference to FIGS. 7 to 10.

At 1225, the device may select a set of symbol locations based at least in part on the identified puncturing matrix, where each symbol location of the selected set of symbol locations corresponds to a plurality of encoded bits of the set of encoded bits. The operations of 1230 may be performed according to the methods described herein. In some examples, aspects of the operations of 1230 may be performed by a symbol selector as described with reference to FIGS. 7 to 10.

At 1230, the device may obtain a set of modulated symbols by mapping, for each symbol location of the selected set of symbol locations, the plurality of encoded bits corresponding to that symbol location to a signal constellation point. The operations of 1235 may be performed according to the methods described herein. In some examples, aspects of the operations of 1235 may be performed by a symbol mapping manager as described with reference to FIGS. 7 to 10.

At 1235, the device may transmit the set of modulated symbols over a communications channel. The operations of 1240 may be performed according to the methods described herein. In some examples, aspects of the operations of 1240 may be performed by a modulated symbol manager as described with reference to FIGS. 7 to 10.

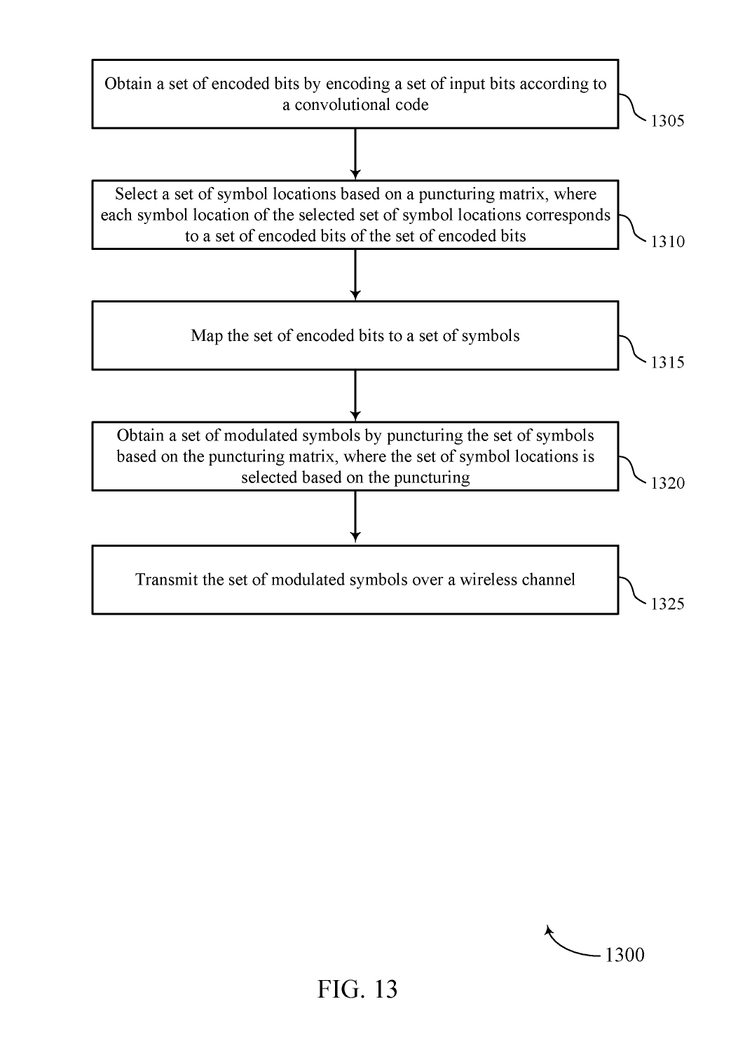

FIG. 13 shows a flowchart illustrating a method 1300 that supports high-rate trellis coded modulations in accordance with aspects of the present disclosure. The operations of method 1300 may be implemented by a device or its components as described herein. For example, the operations of method 1300 may be performed by a communications manager as described with reference to FIGS. 7 to 10. In some examples, a device may execute a set of instructions to control the functional elements of the device to perform the functions described below. Additionally or alternatively, a device may perform aspects of the functions described below using special-purpose hardware.

At 1305, the device may obtain a set of encoded bits by encoding a set of input bits according to a convolutional code. The operations of 1305 may be performed according to the methods described herein. In some examples, aspects of the operations of 1305 may be performed by an encoder as described with reference to FIGS. 7 to 10.

At 1310, the device may select a set of symbol locations based at least in part on a puncturing matrix, where each symbol location of the selected set of symbol locations corresponds to a plurality of encoded bits of the set of encoded bits. The operations of 1310 may be performed according to the methods described herein. In some examples, aspects of the operations of 1310 may be performed by a symbol selector as described with reference to FIGS. 7 to 10.

At 1315, the device may map the set of encoded bits to a plurality of symbols. The operations of 1315 may be performed according to the methods described herein. In some examples, aspects of the operations of 1315 may be performed by a symbol mapping manager as described with reference to FIGS. 7 to 10.

At 1320, the device may obtain a set of modulated symbols based on puncturing the plurality of symbols based at least in part on the puncturing matrix, where the set of symbol locations is selected based at least in part on the puncturing. The operations of 1320 may be performed according to the methods described herein. In some examples, aspects of the operations of 1320 may be performed by a symbol mapping manager as described with reference to FIGS. 7 to 10.

At 1325, the device may transmit the set of modulated symbols over a communications channel. The operations of 1330 may be performed according to the methods described herein. In some examples, aspects of the operations of 1330 may be performed by a modulated symbol manager as described with reference to FIGS. 7 to 10.

It should be noted that the methods described above describe possible implementations, and that the operations and the steps may be rearranged or otherwise modified and that other implementations are possible. Furthermore, aspects from two or more of the methods may be combined.

Techniques described herein may be used for various wired communications systems (e.g., such as DSL, cable systems, etc.) as well as for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and WLAN 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for communication, comprising:
obtaining a set of encoded bits by encoding a set of input bits according to a convolutional code;
selecting a set of symbol locations based at least in part on a puncturing matrix, wherein each symbol location of the selected set of symbol locations corresponds to a plurality of encoded bits of the set of encoded bits;
obtaining a set of modulated symbols by mapping, for each symbol location of the selected set of symbol locations, the plurality of encoded bits corresponding to that symbol location to a signal constellation point; and
transmitting the set of modulated symbols over a communications channel.

2. The method of claim 1, wherein obtaining the set of encoded bits further comprises:
selecting a convolutional code rate, wherein the convolutional code rate comprises a ratio of a number of the set of input bits and a number of the set of encoded bits; and
encoding the set of input bits to obtain the set of encoded bits based at least in part on the selected convolutional code rate.

3. The method of claim 2, wherein obtaining the set of modulated symbols further comprises:
selecting a punctured code rate; and
identifying the puncturing matrix based at least in part on the selected punctured code rate and the convolutional code rate.

4. The method of claim 3, wherein the puncturing matrix is identified based at least in part on the convolutional code rate and a symbol puncturing periodicity.

5. The method of claim 3, wherein the identified puncturing matrix comprises a plurality of columns including a first column and a second column, wherein each value of the first column comprises a first same value and each value of the second column comprises a second same value.

6. The method of claim 5, wherein a number of the plurality columns is based at least in part on a puncturing period.

7. The method of claim 5, wherein the first same value is a one and the second same value is a zero, and wherein the set of modulated symbols includes at least the first column based at least in part on the first same value and a set of punctured symbol locations includes at least the second column based at least in part on the second same value.

8. The method of claim 5, wherein the plurality of columns includes the first column, the second column, and a third column, wherein each value of the first column and the second column is a one and each value of the third column is a zero.

9. The method of claim 5, wherein the plurality of columns includes the first column, the second column, and a third column, wherein each value of the second column and the third column is a one and each value of the first column is a zero.

10. The method of claim 5, wherein the plurality of columns includes the first column, the second column, and a third column, wherein each value of the first column and the third column is a one and each value of the second column is a zero.

11. The method of claim 5, wherein the selected punctured code rate is 3/4 and the convolutional code rate is 1/2, and wherein the plurality of columns includes the first column, the second column, and a third column, wherein each value of the first column and the third column comprises a first same value and each value of the second column comprises a second same value.

12. The method of claim 11, wherein the first same value is a one and the second same value is a zero, and wherein the set of modulated symbols includes at least the first column and the third column based at least in part on the first same value and a set of punctured symbol locations includes the second column based at least in part on the second same value.

13. The method of claim 5, wherein the selected punctured code rate is 5/6 and the convolutional code rate is 1/3, and wherein the plurality of columns includes the first column, the second column, a third column, a fourth column, and a fifth column, wherein each value of the first column and the third column comprises a first same value and each value of the second column, the fourth column, and the fifth column comprises a second same value.

14. The method of claim 13, wherein the first same value is a one and the second same value is a zero, and wherein the set of modulated symbols includes at least the first column and the third column based at least in part on the first same value and a set of punctured symbol locations includes the second column, the fourth column, and the fifth column based at least in part on the second same value.

15. The method of claim 5, further comprising:
puncturing the set of encoded bits based at least in part on the identified puncturing matrix, wherein the mapping of the set of modulated symbols is based at least in part on the punctured set of encoded bits.

16. The method of claim 1, wherein selecting the set of symbol locations based at least in part on the puncturing matrix, further comprises:
mapping the set of encoded bits to a plurality of symbols; and
puncturing the plurality of symbols based at least in part on the puncturing matrix, wherein the set of symbol locations is selected based at least in part on the puncturing.

17. An apparatus for communications, comprising:
a processor,
memory in electronic communication with the processor; and
instructions stored in the memory and executable by the processor, to cause the apparatus to:
obtain a set of encoded bits by encoding a set of input bits according to a convolutional code;
select a set of symbol locations based at least in part on a puncturing matrix, wherein each symbol location of the selected set of symbol locations corresponds to a plurality of encoded bits of the set of encoded bits;
obtain a set of modulated symbols by mapping, for each symbol location of the selected set of symbol locations, the plurality of encoded bits corresponding to that symbol location to a signal constellation point; and
transmit the set of modulated symbols over a communications channel.

18. The apparatus of claim 17, wherein the instructions to obtain the set of encoded bits further are executable by the processor to cause the apparatus to:
select a convolutional code rate, wherein the convolutional code rate comprises a ratio of a number of the set of input bits and a number of the set of encoded bits; and
encode the set of input bits to obtain the set of encoded bits based at least in part on the selected convolutional code rate.

19. The apparatus of claim 18, wherein the instructions to obtain the set of modulated symbols further are executable by the processor to cause the apparatus to:
select a punctured code rate; and
identify the puncturing matrix based at least in part on the selected punctured code rate and the convolutional code rate.

20. The apparatus of claim 19, wherein the puncturing matrix is identified based at least in part on the convolutional code rate and a symbol puncturing periodicity.

21. The apparatus of claim 19, wherein the identified puncturing matrix comprises a plurality of columns including a first column and a second column, wherein each value of the first column comprises a first same value and each value of the second column comprises a second same value.

22. The apparatus of claim 21, wherein a number of the plurality columns is based at least in part on a puncturing period.

23. The apparatus of claim 21, wherein the first same value is a one and the second same value is a zero, and wherein the set of modulated symbols includes at least the first column based at least in part on the first same value and a set of punctured symbol locations includes at least the second column based at least in part on the second same value.

24. The apparatus of claim 21, wherein the plurality of columns includes the first column, the second column, and a third column, wherein each value of the first column and the second column is a one and each value of the third column is a zero.

25. The apparatus of claim 21, wherein the selected punctured code rate is 3/4 and the convolutional code rate is 1/2, wherein the plurality of columns includes the first column, the second column, and a third column, wherein each value of the first column and the third column comprises a first same value and each value of the second column comprises a second same value, wherein the first same value is a one and the second same value is a zero, and wherein the set of modulated symbols includes at least the first column and the third column based at least in part on the first same value and a set of punctured symbol locations includes the second column based at least in part on the second same value.

26. The apparatus of claim 21, wherein the selected punctured code rate is 5/6 and the convolutional code rate is 1/3, wherein the plurality of columns includes the first column, the second column, a third column, a fourth column, and a fifth column, wherein each value of the first column and the third column comprises a first same value and each value of the second column, the fourth column, and the fifth column comprises a second same value, wherein the first same value is a one and the second same value is a zero, and wherein the set of modulation symbols includes at least the first column and the third column based at least in part on the first same value and a set of punctured symbol locations includes the second column, the fourth column, and the fifth column based at least in part on the second same value.

27. The apparatus of claim 21, wherein the instructions are further executable by the processor to cause the apparatus to:
puncture the set of encoded bits based at least in part on the identified puncturing matrix, wherein the mapping of the set of modulated symbols is based at least in part on the punctured set of encoded bits.

28. The apparatus of claim 17, wherein the instructions to select the set of symbol locations based at least in part on the puncturing matrix are further executable by the processor to cause the apparatus to:
map the set of encoded bits to a plurality of symbols; and
puncture the plurality of symbols based at least in part on the puncturing matrix, wherein the set of symbol locations is selected based at least in part on the puncturing.

29. An apparatus for communications, comprising:
means for obtaining a set of encoded bits by encoding a set of input bits according to a convolutional code;
means for selecting a set of symbol locations based at least in part on a puncturing matrix, wherein each symbol location of the selected set of symbol locations corresponds to a plurality of encoded bits of the set of encoded bits;
means for obtaining a set of modulated symbols by mapping, for each symbol location of the selected set of symbol locations, the plurality of encoded bits corresponding to that symbol location to a signal constellation point; and
means for transmitting the set of modulated symbols over a communications channel.

30-42. (canceled)

43. A non-transitory computer-readable medium storing code for communications, the code comprising instructions executable by a processor to:
obtain a set of encoded bits by encoding a set of input bits according to a convolutional code;
select a set of symbol locations based at least in part on a puncturing matrix, wherein each symbol location of the selected set of symbol locations corresponds to a plurality of encoded bits of the set of encoded bits;
obtain a set of modulated symbols by mapping, for each symbol location of the selected set of symbol locations, the plurality of encoded bits corresponding to that symbol location to a signal constellation point; and
transmit the set of modulated symbols over a communications channel.

44-56. (canceled)
